(19) United States
(12) Patent Application Publication
(10) Pub. No.: US 2010/0221969 A1
(43) Pub. Date: Sep. 2, 2010

(54) FUNCTIONAL FIBER, PREPARATION METHOD THEREOF AND FABRIC MADE OF IT

(75) Inventors: Hung-jen CHEN, Taichung Hsien (TW); Tina HUANG, Taichung Hsien (TW)

Correspondence Address: HAMRE, SCHUMANN, MUELLER & LARSON, P.C., P.O. BOX 2902, MINNEAPOLIS, MN, 55402-0902, US

(73) Assignee: NOVEKO TRADING 2008 LLC, Budapest (HU)

(21) Appl. No.: 12/775,241

(22) Filed: May 6, 2010

Related U.S. Application Data
(63) Continuation-in-part of application No. PCT/CN2007/003152, filed on Nov. 7, 2007.

(51) Int. Cl. D03D 15/00; B32B 27/02; D01D 5/12

(52) U.S. Cl. 442/189; 428/401; 428/372; 264/210.1

(57) ABSTRACT

A functional fiber, preparation method thereof and the fabric made of it are provided. The preparation method includes the following steps: rolling and milling plural first polyolefine chips, constant thermoplastic elastomer (TPE) and plural functional particles into plural masterbatches in twin-screw extruder; melting and mixing the plural functional masterbatches and plural second polyolefine chips which are the same as the first polyolefine into the composite material, wherein the final content of the plural functional particles are 1-10 wt. % based on the weight of the composite material; producing fibers with the composite material by spinning, cooling, heat stretching, and heat setting. The fiber may be made into fabric. The fiber and fabric have the function of deodorization, antibiosis, mildew-proof or generating negative ion and further improve the air filtration effect.

### FIELD OF THE INVENTION

The present invention relates generally to a functional fiber, the preparation method thereof and a fabric made from the fiber. More particularly, the present invention relates to a process of making a fiber by subjecting functional particles, thermoplastic elastomer (TPE) and polyolefine to secondary compounding and melt spinning, and weaving the fiber to form a fabric, which exhibits the functions of deodorization or antibacterial, mildew-proof, or capable of generating negative ions or far infrared, and enhancing filtration effect of the fabric and improving the quality of air.

### BACKGROUND OF THE INVENTION

Since environmental pollution is getting worse, the amount of negative ions in the air is decreasing. Furthermore, people spend almost 80% of time living in an indoor environment, and in such a limited space, to keep a good quality of air is necessary. Accordingly, a screen material such as an air filter or a screen window, which is used in an indoor environment and close to human body, has played an important role in maintaining human health. To improve the quality of air by using an air filter is one of the most economic and effective ways of currently known methods. Fabric products containing functional particles capable of generating negative ions, due to their contribution for human health, have gain lots of attention among the textile industries and around the world. However, conventional textile technology has not found a better fabric which is capable of generating negative ions; thereby in general a negative ion generator is still used to generate negative ions. Nevertheless, negative ion generators will generate ozone (O₃), which is harmful for human body and the amount thereof should be kept below 0.12 ppm, and the negative ions generated are merely distributed within 1 meter and the negative ions are effective for a limited period of time.

In view that conventional technology does not provide a technique for manufacturing a fiber and a fabric with better functions, inventors of the present invention have been actively devoted in the research and development for years and continued to improve, and have reached a certain level of results. In 2004, the patent application for the first generation technique was filed as Taiwan patent application No. 93129156, which has been allowed for patent. Besides, through many experiments and improvements, a new technique was generated and applied for patent as U.S. patent application Ser. No. 11/416,155. Recently, a novel technique has been developed and thus the present application is presented.

There are techniques relating to antibacterial deodorization fabrics or fibers in the art. For example, U.S. Pat. No. 4,784,909 relates to a technique of antibacterial deodorization fiber, wherein copper is added into the fiber. U.S. Pat. No. 6,540,807 discloses a technique of antibacterial fabric, wherein the fabric is weaved to form a filter and the fabric includes thermoplastic resin and antibacterial agent. U.S. Pat. No. 5,690,922 discloses a technique of deodorization fiber, wherein the fiber includes tetravalent metal phosphates and divalent metal hydroxides. Nevertheless, the prior arts mentioned above are different from the present invention in technical features. The present invention is based on the achievements obtained from the inventor's continuing research and manufacturing experiences, and it is proved by experimental evidences that the present invention does have practical effects, which meets the requirements for a patent. The patent application is thus filed to protect the achievements of the inventors' research and development.

To improve existing environmental pollution, the present invention is aimed at achieving the objectives of improving indoor air quality (IAQ) and keeping a healthy and health care comfortable environment, and is focused on developing to improve existing fiber structures. A persistent multifunctional self-cleaning filter is developed, wherein the functional fiber can effectively use natural physical fundamental influences such as wind, light, water, and heat in the environment through the mechanisms such as air flow and temperature difference, friction vibration of fibers, and photocatalyst catalytic action to excite the piezoelectric effect, pyroelectric effect, photoelectric effect, catalytic effect, catalyst effect, and slow release effect of the multifunctional particles in the fibers, so as to achieve the healthy self-air cleaning effects, such as sufficiently effective bacteria-killing, anti-bacterial, mildew-proof, anti-mite, negative ion, far-infrared ray, flame-proof, antistatic, anti-electromagnetic wave, and elimination of contaminants such as odor, hair, TVOCs, PMx, CO, CO₂, formaldehyde (HCHO), ozone (O₃), ammonia (NH₃), acetaldehyde (CH₃CHO), acetic acid (CH₃COOH), and so on.

### SUMMARY OF THE INVENTION

The first objective of the present invention is to provide a method for manufacturing a fiber having better functions. The method is characterized in utilizing multifunctional particles, thermoplastic elastomer (TPE) and polyolefine, compounding in a preferred ratio and spinning to obtain the fiber. Through the elasticity of the thermoplastic elastomer, the functional particles can exhibit the best performance. The fiber produced according to the method of the present invention comprises 5-30% by weight of the multifunctional particles (particles such as tourmaline, nano metallic particles, photocatalyst, enzyme, and microcapsule). Once the fibers are weaved to form a web and to compose functional fibers, the indoor air quality (IAQ) can achieve the healthy self-air cleaning effects such as sufficiently effective bacteria-killing, anti-bacterial, mildew-proof, anti-mite, negative ion, far-infrared ray, flame-proof, antistatic, anti-electromagnetic wave, elimination of contaminants such as odor, hair, TVOCs, PMx, and so on, through the mechanisms such as air flow and temperature difference, friction vibration of fibers to excite the piezoelectric effect, pyroelectric effect, catalytic effect, photoelectric effect, catalytic effect, catalyst effect, slow release effect and odor neutralization of the multifunctional particles in the fibers.

The second objective of the present invention is to provide a method for manufacturing a fiber having higher economic effect and being able to generate negative ions. The method is characterized in that the utilized functional particles are submicron tourmaline, through the elasticity of the thermoplastic elastomer, the fabric weaved from the fibers can provide better vibration during flow of air and thus allow the submicron tourmaline to generate negative ions effectively.

The third objective of the present invention is to provide a method for manufacturing a fiber having anti-bacterial effect. The method is characterized in that the utilized functional particles can be nano silver and also enzyme.

The fourth objective of the present invention is to provide a method for manufacturing a fiber capable of exhibiting plant fragrance persistently. The method is characterized in that the utilized functional particles are microcapsules and plant extracted essential oils are encapsulated inside the microcapsules. Through appropriately blocking the release of essential oils with the thermoplastic elastomer, the objective of allowing the fibers to exhibit fragrance persistently is achieved.

For the healthy and health care demand stated above, through the influences of the mechanisms such as air flow and temperature difference, friction vibration of the fibers or light, the multifunctional particles fiber can exhibit a plurality of effects and form a persistent, water-washable, functional, healthy, health care, self-cleaning filter.

### DETAILED DESCRIPTION OF THE PREFERRED EMBODIMENT

The present invention is focused on researching and testing functional fibers. The basic features of the technique is that the fibers of the present invention are manufactured by compounding materials including polyolefine, thermoplastic elastomer (TPE) and multifunctional particle to form functional fibers. Through the mechanisms such as air flow, temperature difference, friction vibration of fibers and sunlight illumination, the piezoelectric effect, pyroelectric effect, photocatalytic effect, catalyst effect, slow release effect, etc. of the multifunctional particles are intensively excited, such that the healthy self-air cleaning effects such as sufficiently effective bacteria-killing, anti-bacterial, mildew-proof, anti-mite, negative ion, far-infrared ray, flame-proof, antistatic, anti-electromagnetic wave, elimination of contaminants such as odor, hair, TVOCs, PMx, and so on, are achieved. The fibers are weaved to form a filter having 3D structure or honeycomb structure, which can decrease wind resistance, enhance loading ability, enhance filtration performance, remove pollen and dust, thus achieving the environmental demands such as persistent, water-washable, acid and basic resistant and the effects of environmental protection and energy saving.

To facilitate the examiner to understand the practicability of the present invention, certain embodiments will be described in detail below.

### A. Basic Technical Features of the Present Invention

The present invention is focused on researching and testing the functional fibers. The basic features of the technique is that the fibers of the present invention are manufactured by compounding functional particles, thermoplastic elastomer and polyolefine, such that the fibers have special functions, and can be used to produce fabrics. The fabrics can be an air filter, or a shoe pad, or a hat, or a screen window, or a curtain, or a TV goggle.

### B. Fibers of the Present Invention

The fibers of the present invention are mainly fibers produced from compounding functional particles (the functional particles can be submicron tourmaline particles, microcapsule encapsulated with plant extracted essential oil, nano silver particles, or enzyme), thermoplastic elastomer (TPE) and polyolefine (for example, polypropylene or polyethylene) together. Through the addition of the thermoplastic elastomer, the fibers of the present invention have better elasticity and friction characteristic, and thus allow the functional particles added to generate better performance.

In the first embodiment of the present invention, the functional particles used are tourmaline having a particle size ranging from 1 μm to 100 nm, and the fibers produced have a diameter of 0.01 mm˜3 mm. The tourmaline particles are in an amount ranging from 1 to 10% by weight based on the total weight of the fiber, and the far-infrared radiation rate of the tourmaline: 0.948 μm (3.48*102 W/m²), particle size distribution: D50 (average particle size: 493 nm). It is found by the experiment that tourmaline particles in an amount of 3% by weight based on the total weight of the fiber will have best economic effect. The web weaved from the fibers exhibits the effects of generating negative ions, far-infrared ray, self-cleaning, deodorization, anti-static, anti-electromagnetic wave. Furthermore, one or more microparticle self-cleaning factors such as nano bamboo carbon, zinc oxide, cupric oxide, ferric oxide, silica, tungsten oxide, manganese oxide, cobalt oxide, nickel oxide can also be added.

In the second embodiment of the present invention, the functional particles used are nano silver particles, so as to generate the functions of anti-bacteria and mildew-proof. The nano silver added is in an amount ranging from 1 to 10% by weight based on the total weight of the fiber, so as to allow the web weaved from the fibers to exhibit the healthy effects of bacteria-killing, anti-bacteria, mildew-proof, anti-mite, and so on. Furthermore, one or more particulate bacteria-killing, anti-bacteria, mildew-proof factors, such as chitin, enzyme, or nano noble metal copper, zinc, aurum, platinum, palladium, niobium, can also be added.

The method of producing functional synthetic fibers of the present invention mainly comprises: preparing plural first polyolefine chips as a substrate, wherein the first polyolefine chips are in the amount of 70%-95% by weight based on the total weight of the fiber and can be polypropylene chips with molecular weight of 3.15×10⁵ g/mole or polyethylene chips with molecular weight of 1.5˜2.5×10⁵ g/mole (as embodiments, the following tests of the present invention are explained by 80 wt. % of polypropylene), and functional particles (as examples, this paragraph is explained with submicron tourmaline), in the amount of 5%-30% by weight based on total weight, and a thermoplastic elastomer (TPE or EPDM), in the amount of 1˜40% by weight based on total weight, and compounding by a twin-screw extruder to form plural masterbatches, and then combining the plural masterbatches with an additional second polyolefine which is the same as the first polyolefine, and melting and mixing the plural masterbatches and the second polyolefine to form a composite material, such that the final content of tourmaline in the composite material is 1-10 wt. %, and then subjecting the composite material to spinning, cooling, thermal stretching, and heat setting to form the fiber. The spinning temperature is within the range of 200° C.˜300° C. (in the actually operated examples of the present invention, the spinning temperature for polypropylene is 200° C.˜250° C. rise, and for polyethylene is 250° C.˜300° C.), the drafting factor is 3˜8 times (in the actually operated examples of the present invention, drafting factor is 6 times), the heat stretching temperature is 100° C.˜160° C. (in the actually operated examples of the present invention, 100° C. hot water is used for stretching), and the heat setting temperature is 70° C.˜100° C.

The melt-spinning mentioned above is conducted by heating and melting the composite material, and extruding the melted material from spinning holes into air, while cooling in the air, winding at a constant speed, and solidifying while the melted composite material is thinning, a fiber is thus formed, and then executing thermal stretching to enhance mechanical properties of the fiber. In the melt-spinning process, the spinnable polymers obtained from a polymeric process at a temperature higher than the melting point thereof are extruded from the holes in the spinning plate, and then cooled and refined to silky solid, and winded at the same time.

### C. Embodiments of the Functional Particles of the Present Invention

To generate negative ions from the fiber, the functional particles used in the present invention are submicron tourmaline particles. To exhibit anti-bacterial and mildew-proof effects, the functional particles used in the present invention are nano silver particles, and as shown in the following test results, the present invention also has better anti-bacterial and mildew-proof effects. Furthermore, to exhibit other functional effects, the functional particles compounded and added in the fiber of the present invention are microcapsule (in the examples of the present invention, the microcapsule is included in an amount of 1% by weight), and a functional material is encapsulated in the microcapsule, wherein the material of the microcapsule can be chitin, and the functional material can be plant extracted essential oil, so as to exhibit the effect of generating fragrance, and as shown in the following test results, the present invention has the effect of persisting the fragrance. Besides, the functional particles used in the present invention can also be enzyme, which contributes to the human body to a certain extent.

### D. Test Examples of the Present Invention

In the test examples of the present invention, polypropylene with molecular weight of 3.15×10⁵ g/mole is used as the substrate. Firstly, 20% by weight of polypropylene and the following materials: (1) functional particles of flame-proof material, 15% by weight, (2) functional particles of submicron tourmaline, 10% by weight, (3) functional particles of anti-bacterial and mildew-proof material, 5% by weight based on the total weight, (4) functional particles of deodorization material (removing gas), 10% by weight, (5) functional particles of anti-static and anti-electromagnetic wave material, 5% by weight, and (6) thermoplastic elastomer (TPE), 35% by weight are provided, and the materials stated above are compounded and granulated by a twin-screw extruder to form plural masterbatches. Then, 40% of the plural masterbatches and 60% of additional polypropylene are provided, and the masterbatches and the additional polypropylene are compounded to a composite material, with the functional masterbatches is in an amount of 32% by weight based on the total weight. Finally, the composite material is subjected to spinning, cooling, thermal stretching, and heat setting to form the fiber. The spinning temperature is within 240° C., drafting factor is 5-6 times, thermal stretching temperature is 100° C., and heat setting temperature is 85° C.

To conduct specific experiments, the fibers of the present invention are further weaved to a fabric; that is, plural fibers in warp direction and plural fibers in weft direction are weaved to form a fabric, the sample size thereof being 101.6 mm×203.2 mm (4 in×8 in), the amount of fibers in warp direction distributed in an unit length is 42 stripe per inch, and the amount of fibers in weft direction distributed in an unit length is 34 stripe per inch.

### a. Mechanical Test of the Present Invention

The mechanical test results of the above samples of the present invention are as below.

(1) Tensile Strength (ASTM D4632: Grasp-Type Tensile Strength Test)

TABLE 1
(kgf/cm₂)

| | | 1 wt. % | 2 wt. % | 3 wt. % | 4 wt. % | 5 wt. % |
|---|---|---|---|---|---|---|
| Test | No | tourma- | tourma- | tourma- | tourma- | tourma- |
| times | additive | line | line | line | line | line |
| 1 | 38.704 | 36.075 | 36.005 | 37.085 | 36.251 | 36.215 |
| 2 | 39.483 | 36.108 | 38.068 | 38.251 | 37.511 | 38.014 |
| 3 | 44.581 | 40.652 | 37.065 | 39.125 | 38.253 | 37.588 |
| 4 | 42.015 | 40.206 | 40.126 | 36.001 | 35.921 | 37.263 |
| 5 | 41.076 | 38.254 | 36.008 | 35.759 | 38.205 | 36.952 |
| Average | 41.1718 | 38.259 | 37.4544 | 37.2442 | 37.2282 | 37.2064 |

From the experiment results of Table 1, it is realized that as the tourmaline content gets higher, the tensile strength will decrease gradually, while it is still kept at the required strength, and therefore the tourmaline particles added in the present invention are preferably in the amount of 1˜5% by weight based on the total weight.

(2) Mullen Burst Strength (ASTM D3786: Mullen Burst Strength Test)

TABLE 2
(kgf/cm²)

| | | 1 wt. % | 2 wt. % | 3 wt. % | 4 wt. % | 5 wt. % |
|---|---|---|---|---|---|---|
| Test | No | tourma- | tourma- | tourma- | tourma- | tourma- |
| times | additive | line | line | line | line | line |
| 1 | 21.886 | 23.728 | 22.765 | 21.345 | 22.706 | 22.086 |
| 2 | 23.725 | 19.174 | 21.129 | 22.349 | 20.609 | 20.308 |
| 3 | 26.816 | 24.627 | 21.764 | 22.047 | 21.086 | 21.117 |
| 4 | 21.314 | 18.032 | 21.796 | 19.449 | 21.625 | 20.598 |
| 5 | 22.108 | 24.499 | 22.229 | 23.603 | 21.855 | 21.717 |
| Average | 23.1698 | 22.012 | 21.9366 | 21.7586 | 21.5762 | 21.1652 |

From Table 2, it is realized that as the tourmaline content gets higher, the Mullen burst strength of the fabric of the present invention will decrease, too. When tourmaline content is 1% by weight, the warpwise Mullen burst strength decreases by approximately 5%, and when tourmaline content is 5% by weight, the warpwise Mullen burst strength decreases by approximately 8.6%, while the Mullen burst strength is still kept relatively high. Thus, within the range of adding 1-5% by weight of tourmaline, the Mullen burst strength is not affected.

(3) Washing Fastness Test (Conditions During Test: Humidity 58%; Temperature 29° C.)

TABLE 3
(Ion/cc)

| Added amount | | Average after test | Decrease percentage of |
|---|---|---|---|
| of tourmaline | Before test | for five times | negative ion |
| 1 wt. % | 265 | 263 | 99% |
| 2 wt. % | 350 | 343 | 98% |
| 3 wt. % | 383 | 365 | 95% |
| 4 wt. % | 435 | 416 | 96% |
| 5 wt. % | 489 | 461 | 94% |

As shown in Table 3, the fastness is well maintained before and after test. The amount of negative ions generated does not decrease due to washing.

### b. Negative Ion Release Analysis of the Present Invention

(1) Negative Ion Static Release Performance Analysis:

Static mode negative ion release performance analysis, environment condition: humidity 58%; temperature 28° C.

TABLE 4
(Ion/cc)

| Added | | | | | |
|---|---|---|---|---|---|
| amount of | Filter | Filter | Filter | Filter | Filter |
| tourmaline | 1 layer | 2 layers | 3 layers | 4 layers | 5 layers |
| 1 wt. % | 265 | 412 | 532 | 620 | 712 |
| 2 wt. % | 350 | 523 | 652 | 734 | 825 |
| 3 wt. % | 412 | 589 | 756 | 834 | 985 |
| 4 wt. % | 465 | 652 | 852 | 935 | 1080 |
| 5 wt. % | 489 | 712 | 867 | 973 | 1115 |

By analyzing Table 4, it is realized that the added amount of tourmaline and number of layers are both significant factors of influence, wherein number of layers is the major factor of influence. In the case of one layer, for different contents of submicron tourmaline polypropylene filter material, negative ions are released by 265-489 ion/cc. For 1% by weight of submicron tourmaline polypropylene filter material, negative ions are released by 265-712 ion/cc. The difference between them is 223 ion/cc under the same volume. That is, an increase in layers is more effective than an increase in tourmaline amount, for the increase of negative ion release amount.

(2) Negative Ion Dynamic Release Performance Analysis:

Dynamic mode negative ion release performance analysis, environment condition: humidity 64%; temperature 29° C.

TABLE 5
(%)

| Added | | | | | |
|---|---|---|---|---|---|
| amount of | | | | | |
| tourmaline | 1 layer | 2 layers | 3 layers | 4 layers | 5 layers |
| 1 wt. % | 1025 | 1695 | 2213 | 2732 | 2956 |
| 2 wt. % | 1523 | 2573 | 3012 | 3325 | 3456 |
| 3 wt. % | 1856 | 3212 | 3512 | 3759 | 3956 |
| 4 wt. % | 1956 | 3512 | 3725 | 3856 | 4120 |
| 5 wt. % | 1983 | 3603 | 3901 | 3921 | 4220 |

From Table 5, it is realized that for dynamic negative ion release amount, the added amount of tourmaline and the number of filter layers are both important factors, wherein the number of filter layers is the major important factor.

### c. Deodorization and Antibacterial Performance Test of the Present Invention

The deodorization and antibacterial performance test results of the fabric weaved from the fibers of the present invention are shown below. Table 6 is obtained by respectively applying JEM 1467 test method to the fabrics of the present invention for testing the removing performance of the concentration of ammonia (NH₃) and acetaldehyde (CH₃CHO) and then testing the concentration of acetic acid (CH₃COOH). Based on Table 6, the fabric of the present invention has better deodorization performance.

TABLE 6

| | | acetal- | |
|---|---|---|---|
| | ammonia | dehyde | acetic acid |
| Item | (NH₃) | (CH₃CHO) | (CH₃COOH) |
| The beginning concentration | 24.00 PPM | 8.00 PPM | 0.20 PPM |
| The concentration after 30 | 4.00 PPM | 1.00 PPM | 0.04 PPM |
| minutes | | | |
| The removing rate of multi | 84.33% | 87.50% | 80.00% |
| pollution | | | |
| Total Removing Rate | | 84.58% | |

### d. Test Example III

The antibacterial performance test results of the fabric weaved from the fibers of the present invention are shown below.

TABLE 7

| | Initial | | |
|---|---|---|---|
| | Inoculation | | |
| | (CFU/ml) | Contact Time | Reduction (%) |
| Test strain | (0 hr) | (1 hour later) | (1 hour later) |
| Staphylococcus aureus | 1.0 × 10⁵ | 3.0 × 10⁴ | 94.8 |
| Escherichia coli | 2.1 × 10⁵ | 1.6 × 10³ | 99.2 |
| Klebsiella pneumoniae | 7.3 × 10⁵ | 3.0 × 10⁴ | 95.8 |

TABLE 8

| | | |
|---|---|---|
| Mildew- | JIS Z 2911 Aspergillus niger | 0 growth |
| killing | ATCC9642 | |
| | JIS Z 2911 Penicillium spp. | 0 growth |
| | ATCC9849 | |
| | JIS Z 2911 Chaetomium globosum | 0 growth |
| | ATCC6205 | |
| | JIS Z 2911 Myrothecium | 0 growth |
| | verrucaria ATCC9095 | |
| | ASTM G21-96 Trichophyton | 0 growth |
| | mentagrophytes ATCC9533 | |

TABLE 9

| | Antibacterial mildew | | |
|---|---|---|---|
| Test item | proof zone | | Antibacterial effect |
| Staphylococcus aureus | 10 | mm | 100(%) |
| Escherichia coli | 4.5 | mm | 100(%) |
| Klebsiella pneumoniae | 3.5 | mm | 100(%) |
| Staphylococcus aureus | 12 | mm | 100(%) |
| Escherichia coli | 2 | mm | 100(%) |

From ASTM E 2149-01 test method of Table 7 and JISZ2911 and ASTM G21-96 test methods of Table 8, it is proved that the fibers added with the nano silver particles of the present invention have better anti-bacterial and mildew-proof performance. From AATCC 147 test method of Table 9, it is realized that the present invention with synthetic enzyme added also has better anti-bacterial performance.

### e. Fragrance Persistency Performance Test of the Present Invention

The fragrance persistency performance test of the fabrics weaved from the fibers of the present invention. As shown in Table 10, the present to invention still has effective fragrance effect after three months, which is therefore sufficient to prove that the manufacturing method of the present invention and the fibers manufactured therefrom can ensure the fragrance persistency of the essential oil in the microcapsules.

TABLE 10
Fragrance persistency test for microcapsules
added with essential oils

| | | Result (test |
|---|---|---|
| Test item | Result (Initiation) | after three months) |
| smell function evaluation | 3.4 | 4.0 |

Furthermore, the result of the following table is obtained by GC-MS test for the web fiber with natural essential oil of the present invention. As shown in Table 11, the web of the present invention can efficiently achieve the cleaning ability of essential oil components.

TABLE 11

| | | Testing | Testing | Testing | Testing |
|---|---|---|---|---|---|
| | | result | limit | result | limit |
| Compound name | CAS number | (ug) | (ug) | (ug/g) | (ug/g) |
| Acetone | 000067-64-1 | 0.38 | 0.1 | 0.25 | 0.06 |
| 2-methylpentane | 000107-83-5 | 0.11 | 0.1 | 0.07 | 0.06 |
| 1,1-Dimethylallene | 000598-25-5 | 0.48 | 0.1 | 0.31 | 0.06 |
| 2,4-dimethylHexane | 000589-43-5 | 0.22 | 0.1 | 0.14 | 0.06 |
| 3,3-dimethylHexane | 000563-16-6 | 0.14 | 0.1 | 0.09 | 0.06 |
| 2,3-dimethylHexane | 000584-94-1 | 0.16 | 0.1 | 0.11 | 0.06 |
| 4-methylHeptane | 000589-53-7 | 0.12 | 0.1 | 0.07 | 0.06 |
| 2,4- | 002213-23-2 | 0.18 | 0.1 | 0.12 | 0.06 |
| Dimethylheptane | | | | | |
| 4-methylOctane | 002216-34-4 | 0.13 | 0.1 | 0.08 | 0.06 |
| PARA CYMENE | 000099-87-6 | 5.62 | 0.1 | 3.64 | 0.06 |
| .alpha.-pinene | 000080-56-8 | 36.74 | 0.1 | 23.78 | 0.06 |
| Fenchene | 000471-84-1 | 0.19 | 0.1 | 0.12 | 0.06 |
| Camphene | 000079-92-5 | 2.06 | 0.1 | 1.33 | 0.06 |
| SABINENE | 003387-41-5 | 21.76 | 0.1 | 14.09 | 0.06 |
| Pseudopinene | 000127-91-3 | 164.98 | 0.1 | 106.78 | 0.06 |
| n-Octanal | 000124-13-0 | 0.35 | 0.1 | 0.23 | 0.06 |
| p-Cymene | 000099-87-6 | 6.58 | 0.1 | 4.26 | 0.06 |
| LIMONENE | 000138-86-3 | 213.81 | 0.1 | 138.39 | 0.06 |
| Gamma-Terpinene | 000099-85-4 | 29.63 | 0.1 | 19.18 | 0.06 |
| Terpinolene | 000586-62-9 | 1.85 | 0.1 | 1.20 | 0.06 |
| D-3-carene | 013466-78-9 | 0.98 | 0.1 | 0.64 | 0.06 |
| Isopropenyltoluene | 026444-18-8 | 12.83 | 0.1 | 8.30 | 0.06 |

### f. Anti-Static Performance Test of the Present Invention

From the following table 12, according to AATCC 76-1995, temperature 20° C., humidity 40%, it is found that the web weaved from the fibers of the present invention has good anti-static performance ability.

TABLE 12

| Test item | Test result |
|---|---|
| fabric surface resistance | >E+11 |
| (Ω/square) | |

### g. Anti-Electromagnetic Wave Blocking Performance

From Table 13, the web weaved from the fibers of the present invention has better anti-electromagnetic wave blocking performance according to AATCC D4935-1999.

TABLE 13

| Test item | | Test result |
|---|---|---|
| electromagnetic wave blocking effect DB | 300 MHZ | 0.2 |
| electromagnetic wave blocking effect DB | 1800 MHZ | 0.1 |

### h. Flame-Proof Performance Test of the Present Invention

From the following table, the shoe pad of the present invention has flameproof ability VTM-0 according to UL 94-97 method.

TABLE 14

| Test item | Sample 1 | Sample 2 | Sample 3 | Sample 4 | Sample 5 | VTM-0 |
|---|---|---|---|---|---|---|
| Sample thickness | 2.95 mm | 2.82 mm | 2.84 mm | 2.91 mm | 2.85 mm | |
| Remaining flame time of | 0 | 0 | 0 | 0 | 0 | ≦10 secs |
| each sample t1 (sec) | | | | | | |
| Remaining flame time of | 0 | 0 | 0 | 0 | 0 | ≦10 secs |
| each sample t2 (sec) | | | | | | |
| Total remaining flame time | 0 | | | | | ≦50 secs |
| of every five samples | | | | | | |
| The remaining flame time | 0 | 0 | 0 | 0 | 0 | ≦30 secs |
| plus remaining ember time | | | | | | |
| of each sample after the | | | | | | |
| second ignition t2 + t3 (sec) | | | | | | |
| The remaining flame or | no | no | no | no | no | no |
| remaining embers of any | | | | | | |
| sample burns the clamping | | | | | | |
| apparatus | | | | | | |
| Cotton is burned by burned | no | no | no | no | no | no |
| particles or melted drops | | | | | | |

### i. Summary Table of Test Results for Major Examples

Summary table of the test results for major examples of the present invention and the testing institution are listed in Table 15.

TABLE 15

| Function | Effect | Method/species | Time | Performance | testing institution |
|---|---|---|---|---|---|
| Nano silver | Bacteria- | ASTM 2149-01 | contact time | 94.8 | SGS Taiwan |
| | killing | Staphylococcus aureus | 1 hour | | testing technology |
| | | (ATCC#6538) | | | |
| | | ASTM 2149-01 | | 99.2 | SGS Taiwan |
| | | Escherichia coli | | | testing technology |
| | | (ATCC#8739) | | | |
| | | ASTM 2149-01Z | | 95.8 | SGS Taiwan |
| | | Klebsiella pneumoniae | | | testing technology |
| | | (ATCC#4352) | | | |

| | | | |
|---|---|---|---|
| Mildew- | JIS Z 2911 | 0 growth | SGS Taiwan |
| killing | Aspergillus niger ATCC9642 | | testing technology |
| | JIS Z 2911 Penicillium spp. ATCC9849 | 0 growth | SGS Taiwan |
| | | | testing technology |
| | JIS Z 2911 Chaetomium globosum ATCC6205 | 0 growth | SGS Taiwan |
| | | | testing technology |
| | JIS Z 2911 Myrothecium verrucaria | 0 growth | SGS Taiwan |
| | ATCC9095 | | testing technology |
| | ASTM G21-96 Trichophyton mentagrophytes | 0 growth | SGS Taiwan |
| | ATCC9533 | | testing technology |

| | | | antibacterial | Growth-free | |
|---|---|---|---|---|---|
| Function | Effect | Method/species | effect (%) | zone (mm) | Testing institution |
| Synthetic | Bacteria- | A.A.T.C.C 147-1998 | 100% | 10 mm | SGS Taiwan |
| enzyme | inhibiting | Staphylococcus aures | | | testing technology |
| | | (ATCC#6538) | | | |
| | | A.A.T.C.C 147-1998 | 100% | 13 mm | EPA US |
| | | Staphylococcus aureus | | | Environment |
| | | (ATCC#6538) | | | Protection Agency |
| | | A.A.T.C.C 147-1998 | 100% | 4.5 mm | SGS Taiwan |
| | | Escherichia coli | | | testing technology |
| | | (ATCC#8739) | | | |
| | | A.A.T.C.C 147-1998 | 100% | 1 mm | EPA US |
| | | Escherichia coli | | | Environment |
| | | (ATCC#8739) | | | Protection Agency |
| | | A.A.T.C.C 147-1998 | 100% | 3.5 mm | SGS Taiwan |
| | | Klebsiella pneumoniae | | | testing technology |
| | | (ATCC#4352) | | | |
| | | A.A.T.C.C 147-1998 | 100% | 6 mm | EPA US |
| | | Klebsiella pneumoniae | | | Environment |
| | | (ATCC#4352) | | | Protection Agency |
| | Mildew- | AATCC 30 PART III | 0 growth | | SGS Taiwan |
| | proof | Aspergillus niger | | | testing technology |
| | | ATCC6275 | | | |
| Negative ion | Oxygen | 4M*4M*4M negative ion | 1856 (Ion/cc) | | TTRI Taiwan |
| amount | negative | release amount | 1956 (Ion/cc) | | Textile Research |
| | ion | | 1983 (lon/cc) | | Institute |
| | | Washing test (washing | Over 98% | | |
| | | for 20 times with water) | | | |
| Far-infrared | energy | Far-infrared radiation rate | 0.948 | Average | Industrial Technology |
| ray | | (50° C.): measure 3-15 μm | | radiation rate | Research Institute, |
| | | average radiation rate | | | Energy and Environment |
| | | | | | Research Laboratories |

### E. Features of the Present Invention

1. The fibers of the present invention add functional particles (such as submicron tourmaline). The mechanical strength of the filter web thus produced is only slightly decreased, which has no significant influence.

2. The fibers of the present invention add functional particles (such as submicron tourmaline). The washing fastness experiment shows that the fibers thus produced still holds predetermined functions.

3. The present invention adds thermoplastic elastomer and submicron tourmaline particles. For filtration performance, the submicron tourmaline particle can efficiently enhance filtration performance under electrostatic adhesion theory since the tourmaline is of negative electricity. On the other hand, because of the thermoplastic elastomer, the filter produced has better elasticity and friction. Since water decomposes to negative ions (H₃O₂⁻) due to the special effect of pyroelectricity and piezoelectricity, vibration frequency increases, friction force grows, a large amount of negative ions is released in dynamic model, so as to satisfy the standard requirement (1000-2000 ion/cc) for human health. Through experiment, it is found that the negative ion release amount of the present invention in 4 m×4 m×4 m volume is about 1856˜1983 (Ion/cc), which has good release amount.

4. When the present invention adds microcapsule with essential oil, since thermoplastic elastomer is also added, through the effect of the thermoplastic elastomer, the essential oil can be prevented from evaporating too soon, and the essential oil can be released at nearly fixed amount, so as to enhance the duration.

5. The filter of the present invention has antibacterial effect when nano silver particles are added in the fibers of the present invention.

6. The present invention has been proved by experiments that it has good bacteria-inhibiting and mildew-proof effect when enzyme is added in the fibers of the present invention.

7. It has been proved by experiments that indoor air quality can be effectively improved as shown in Table 15 by using the filter produced from the fibers of the present invention.

What mentioned above is only feasible example of the present invention, which is not used to limit the patent scope of the present invention. All variations made based on the contents, features and spirits of the claims below should be within the patent scope of the present invention.

What is claimed is:

1. A manufacturing method for a functional fiber, comprising:
(a) preparing the following materials:
(a1) a first polyolefine chip, 70%-95% by weight, as a substrate;
(a2) at least one of plural functional particles, 5%-30% by weight; and
(a3) a thermoplastic elastomer (TPE), 1%-40% by weight;
(b) compounding the first polyolefine, the plural functional particles and the thermoplastic elastomer to form plural masterbatches;
(c) providing the plural masterbatches and a second polyolefine chip, the second polyolefine being formed of the same material as the first polyolefine, and melting and mixing the plural masterbatches and the second polyolefine chip to form a composite material, such that the content of the plural functional particles is 1-10 wt. % based on the weight of the composite material; and
(d) subjecting the composite material to spinning, cooling, thermal stretching, and heat setting to form the fiber.

2. The manufacturing method according to claim 1, wherein the first polyolefine and the second polyolefine are both polypropylene.

3. The manufacturing method according to claim 2, wherein the molecular weight of the polypropylene is 3.15×10⁵ g/mole.

4. The manufacturing method according to claim 1, wherein the first polyolefine and the second polyolefine are both polyethylene.

5. The manufacturing method according to claim 4, wherein the molecular weight of the polyethylene is 1.5˜2.5×10⁵ g/mole.

6. The manufacturing method according to claim 1, wherein the functional particle can be a microcapsule and a functional material is encapsulated inside the microcapsule.

7. The manufacturing method according to claim 6, wherein the functional material is a plant extracted essential oil.

8. The manufacturing method according to claim 6, wherein the microcapsule is made of one or more materials selected from the group consisting of chitin, polyurethane elastomer and thermoplastic elastomer.

9. The manufacturing method according to claim 1, wherein the functional particles are made of at least one material selected from the group consisting of chitin, enzyme, and nano noble metal copper, zinc, aurum, platinum, palladium, niobium, and silver.

10. The manufacturing method according to claim 1, wherein the functional particles are made of at least one material selected from the group consisting of submicron tourmaline, nano bamboo carbon, zinc oxide, cupric oxide, ferric oxide, silica, tungsten oxide, manganese oxide, cobalt oxide, and nickel oxide.

11. The manufacturing method according to claim 10, wherein the particle size of the submicron tourmaline is ranging from 1 μm to 100 nm.

12. The manufacturing method according to claim 1, wherein the spinning temperature is 250° C.˜300° C. rise, the heat stretching temperature is 100° C., and the heat setting temperature is 90° C.

13. A functional fiber produced by the manufacturing method according to claim 1, wherein the diameter of the fiber is 0.01 mm˜3 mm, and the fiber includes plural functional particles.

14. The fiber according to claim 13, wherein the functional particle includes a microcapsule and a functional material is encapsulated inside the microcapsule.

15. The fiber according to claim 14, wherein the functional material is a plant extracted essential oil.

16. The fiber according to claim 14, wherein the microcapsule is made of one or more materials selected from the group consisting of chitin, polyurethane elastomer and thermoplastic elastomer.

17. The fiber according to claim 13, wherein the functional particles are made of at least one material selected from the group consisting of chitin, enzyme, or nano noble metal copper, zinc, aurum, platinum, palladium, niobium, and silver.

18. The fiber according to claim 13, wherein the functional particles are made of at least one material selected from the group consisting of submicron tourmaline, nano bamboo carbon, zinc oxide, cupric oxide, ferric oxide, silica, tungsten oxide, manganese oxide, cobalt oxide, nickel oxide.

19. The fiber according to claim 18, wherein the particle size of the submicron tourmaline is ranging from 1 μm to 100 nm.

20. A fabric produced from the fiber according to claim 13, wherein the fabric comprises plural fibers in warp direction and plural fibers in weft direction weaved with each other.

21. The fabric according to claim 20, wherein the fabric is selected from one of air filter, shoe pad, hat, screen window, curtain, and TV goggle.
